(19) United States
(12) Patent Application Publication
(10) Pub. No.: US 2014/0053161 A1
(43) Pub. Date: Feb. 20, 2014

(54) Method for Adaptive Scheduling of Multimedia Jobs

(71) Applicant: GREG SADOWSKI, Cambridge, MA (US)

(72) Inventor: GREG SADOWSKI, Cambridge, MA (US)

(73) Assignee: Advanced Micro Devices, Inc., Sunnyvale, CA (US)

(21) Appl. No.: 13/585,223

(22) Filed: Aug. 14, 2012

(51) Int. Cl. G06F 9/46

(52) U.S. Cl. 718/102

(57) ABSTRACT

Systems and methods describe herein provide a method of for managing task scheduling on a accelerated processing device. Duration characteristics for a plurality of offset values are determined based on execution of first and second processing tasks within an accelerated processing device. An offset value from the plurality of offset values is selected indicating a difference in an execution start time between the first processing task and the second processing task. Additional executions of the first and second processing tasks are scheduled based on the selected offset value.

### BACKGROUND

1. Field of the Invention

The present invention is generally directed to computing systems. More particularly, the present invention is directed to adaptive power saving scheduling of multimedia processing tasks.

2. Background Art

The desire to use a graphics processing device unit (GPU) for general computation has become much more pronounced recently due to the GPU's exemplary performance per unit power and/or cost. The computational capabilities for GPUs, generally, have grown at a rate exceeding that of the corresponding central processing unit (CPU) platforms. This growth, coupled with the explosion of the mobile computing market (e.g., notebooks, mobile smart phones, tablets, etc.) and its necessary supporting server/enterprise systems, has been used to provide a specified quality of desired user experience. Consequently, the combined use of CPUs and GPUs for executing workloads with data parallel content is becoming a volume technology.

However, GPUs have traditionally operated in a constrained programming environment, available primarily for the acceleration of graphics. These constraints arose from the fact that GPUs did not have as rich a programming ecosystem as CPUs. Their use, therefore, has been mostly limited to two dimensional (2D) and three dimensional (3D) graphics and a few leading edge multimedia applications, which are already accustomed to dealing with graphics and video application programming interfaces (APIs).

With the advent of multi-vendor supported OpenCL® and DirectCompute®, standard APIs and supporting tools, the limitations of the GPUs in traditional applications has been extended beyond traditional graphics. Although OpenCL and DirectCompute are a promising start, there are many hurdles remaining, to creating an environment and ecosystem that allows the combination of a CPU and a GPU to be used as fluidly as the CPU for most programming tasks.

Existing computing systems often include multiple processing devices. For example, some computing systems include both a CPU and a GPU on separate chips (e.g., the CPU might be located on a motherboard and the CPU might be located on a graphics card) or in a single chip package. Both of these arrangements, however, still include significant challenges associated with (i) separate memory systems, (ii) providing quality of service (QoS) guarantees between processes, (iii) programming model, (iv) compiling to multiple target instruction set architectures (ISAs), and (v) efficient scheduling—all while minimizing power consumption.

Many applications schedule hardware jobs periodically. For example a video player will schedule jobs for video decoding and video-post-processing operations. Such operations require access to main memory, which results in a competition for memory access. The competition for memory may result in extra power consumption by the system.

### SUMMARY OF EMBODIMENTS

A potential solution to this problem is scheduling the hardware jobs with an appropriate offset, e.g., a time offset, between them. Scheduling hardware jobs with an appropriate offset between them will result in less competition for memory access and faster processing. This, in tam results in less power consumption. Additionally, an appropriate offset may result in the above-mentioned benefits while addressing, at least in part, a drawback of decreased overall idle-time of an entire processing chain (such a decrease in idle time may otherwise result in the system being unable to perform certain power saving operations—e.g., place system in a power-save mode), which may otherwise increase power consumption. Embodiments of methods and systems having an appropriate offset value for scheduling tasks on a GPU are disclosed herein.

Although GPU's, accelerated processing units (APUs), and general purpose use of the graphics processing unit (GPGPU) are commonly used terms in this field, the expression “accelerated processing device (APD)” is considered to be a broader expression. For example, APD refers to any cooperating collection of hardware and software that performs those functions and computations associated with accelerating graphics processing tasks, data parallel tasks, or nested data parallel tasks in an accelerated, manner with respect to resources such as conventional CPUs, conventional CPUs, and/or combinations thereof.

Embodiments of some aspects of the disclosed invention, in certain circumstances, provide an APD, a computer readable medium, and a method including determining duration characteristics for a plurality of offset values based on execution of first and second processing tasks within an accelerated processing device, selecting an onset value from the plurality of offset values indicating a difference in an execution start time between the first processing task and the second processing task, and scheduling additional executions of the first and second processing tasks based on the selected offset value.

According to another embodiment of some aspects of the present invention, a computer readable medium storing instructions is provided. Execution of the instructions by a computing device causes the computing device to perform operations including determining duration characteristics for a plurality of offset values based on execution of first and second processing tasks within an accelerated processing device, selecting an offset value from the plurality of offset values indicating a difference in an execution start time between the first processing task and the second processing task, and scheduling additional executions of the first and second processing tasks based on the selected offset value.

Additional features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of some aspects of the present invention and, together with the description, further serve to explain the principles of the invention and to enable a person skilled in the pertinent art to make and use the invention. Various embodiments of the present invention are described below with reference to the drawings, wherein like reference numerals are used to refer to like elements throughout.

FIG. 1 is an illustrative block diagram of a processing system, in accordance with embodiments of the present invention.

FIG. 2 is an illustrative block diagram illustration of a scheduling system, in accordance with embodiments of the present invention.

FIG. 3 is a block diagram illustrating duration characteristics during a training session, according to an embodiment of the present invention.

FIG. 4 is a flowchart illustrating an exemplary method for managing task scheduling on an accelerated processing device, according to an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS

In the detailed, description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage, or mode of operation. Alternate embodiments may be devised, without departing from the scope of the invention, and well-known elements of the invention may not be described in detail or may be omitted so as not to obscure the relevant details of the invention. In addition, the terminology used herein is for the purpose of describing particular embodiments only and is not intended, to be limiting of the invention. For example, as used herein, the singular forms “a,” “an” and “the” are intended to include the plural forms as well, unless the context clearly indicates otherwise. It will be further understood that the terms “comprises,” “comprising,” “includes” and/or “including.” when used herein, specify the presence of stated features, integers, steps, operations, elements, and/or components, but do not preclude the presence or addition of one or more other features, integers, steps, operations, elements, components, and/or groups thereof.

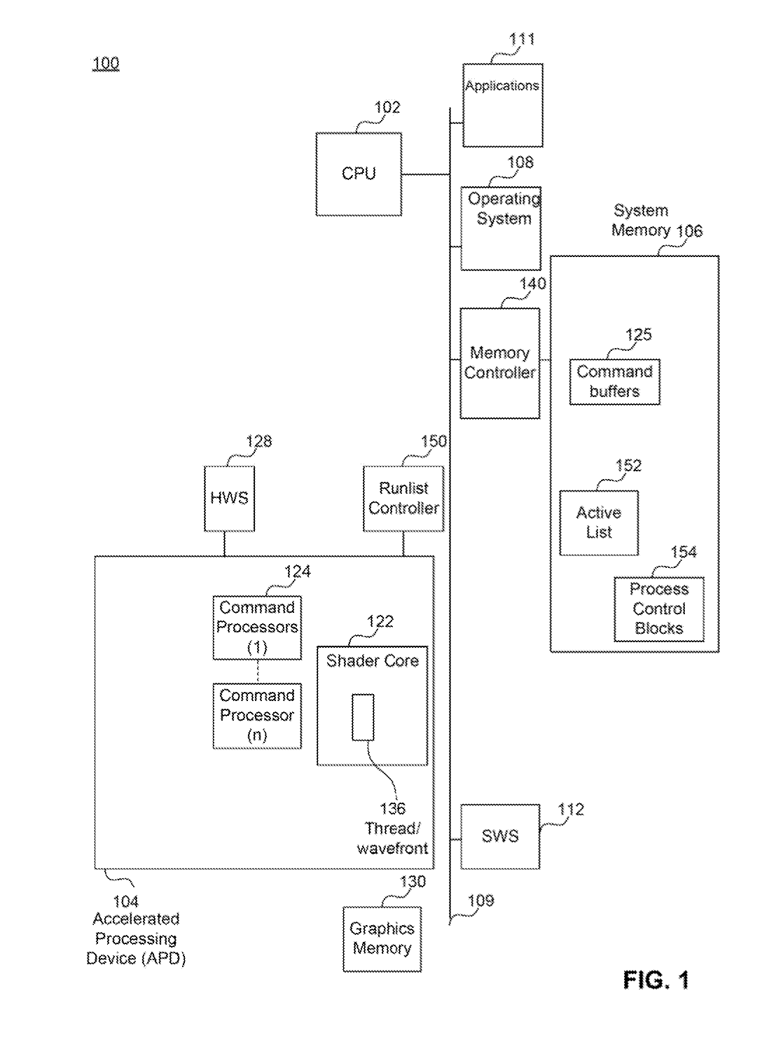

FIG. 1 is an exemplary illustration of a unified computing system 100 including two processors, a CPU 102 and an APD 104. CPU 102 can include one or more single or multi core CPUs. In one embodiment of the present invention, the system 100 is formed on a single silicon die or package, combining. CPU 102 and APD 104 to provide a unified programming and execution environment. This environment enables the APD 104 to be used as fluidly as the CPU 102 for some programming tasks. However, it is not an absolute requirement of this invention that the CPU 102 and APD 104 be formed on a single silicon die, in some embodiments, it is possible for them to be formed separately and mounted on the same or different substrates.

In one example, system 100 also includes a memory 106, an operating system 108, and a communication infrastructure 109. The operating system 108 and the communication infrastructure 109 are discussed in greater detail below.

The system 100 also includes a software scheduler (SWS) 112 and a memory management unit 116, such as input/output memory management unit (IOMMU). Components of system 100 can be implemented as hardware, firmware, software, or any combination thereof. A person of ordinary skill in the art will appreciate that system 100 may include one or more software, hardware, and firmware components in addition to, or different from, that shown in the embodiment shown in FIG. 1.

CPU 102 can include (not shown) one or more of to control processor, field programmable gate array (FPGA), application specific integrated circuit (ASIC), or digital signal processor (DSP), CPU 102, for example, executes the control logic, including the operating system 108. SWS 112, and applications 111, that control the operation of computing system 100. In this illustrative embodiment, CPU 102, according to one embodiment, initiates and controls the execution of applications iii by, for example, distributing the processing associated with that application across the CPU 102 and other processing resources, such as the APD 104.

APD 104, among other things, executes commands and programs for selected functions, such as graphics operations and other operations that may be, for example, particularly suited for parallel processing. In general, APD 104 can be frequently used for executing graphics pipeline operations, such as pixel rations, geometric computations, and rendering an image to a display. In various embodiments of the present invention, APD 104 can also execute compute processing operations (e.g., those operations unrelated to graphics such as, for example, video operations, physics simulations, computational fluid dynamics, etc.), based on commands or instructions received from CPU 102. In an example embodiment, APD 104 includes a unified video decoder (not illustrated). A unified video decoder (UVD) can handle video processing, functionality, such as variable length coding (VLC), context-adaptive variable length coding (CAVLC), context-adaptive binary arithmetic coding, frequency transform and pixel prediction. The UVD can then pass the data to shader core 122 for video post processing operations.

In an illustrative embodiment. CPU 102 transmits selected commands to APD 104. These selected commands can include graphics commands and other commands amenable to parallel execution. These selected commands, that can also include compute processing commands, can be executed substantially independently from CPU 102.

APD 104 can include its own compute units (not shown), such as, but not limited to, one or more SIMD processing cores. As referred to herein, a SIMD is a pipeline, or programming model, where a kernel is executed concurrently on multiple processing elements each with its own data and a shared program counter. All processing elements execute an identical set of instructions. The use of predication enables work-items to participate or not for each issued command.

In one example, each APD 104 compute unit can include one or more scalar and/or vector floating-point units and/or arithmetic and logic units (ALUs). The APD compute unit can also include special purpose processing units (not shown), such as inverse-square root units and sine/cosine units. In one example, the APD compute units are referred to herein collectively as shader core 122.

Having one or more SIMDs, in general, makes APD 104 ideally suited for execution of data-parallel tasks such as those that are common in graphics processing.

Some graphics pipeline operations, such as pixel processing, and other parallel computation operations, can require that the same command stream or compute kernel be performed on streams or collections of input data elements. Respective instantiations of the same compute kernel can be executed concurrently on multiple compute units in shader core 122 in order to process such data elements in parallel. As referred to herein, for example, a compute kernel is a function containing instructions declared in a program and executed on an APD. This function is also referred to as a kernel, a shader, a shader program, or a program.

Within the system 100, APD 104 includes its own memory, such as graphics memory 130 (although memory 130 is not limited to graphics only use). Graphics memory 130 provides a local memory for use during computations in APD 104. Individual compute units (not shown) within shatter core 122 can have their own local data store (not shown). In one embodiment, APD 104 includes access to local graphics memory 130, as well as access to the memory 106. In another embodiment, APD 104 can include access to dynamic random access memory (DRAM) or other such memories (not shown) attached directly to the APD 104 and separately from memory 106.

In the example shown, APD 104 also includes one or “n” number of command processors (CPs) 124. CP 124 controls the processing within APD 104. CP 124 also retrieves commands to be executed from command buffers 125 in memory 106 and coordinates the execution of those commands on APD 104.

In one example. CPU 102 inputs commands based on applications 111 into appropriate command butlers 125. As referred to herein, an application is the combination of the program parts that will execute on the compute units within the CPU and APD. A plurality of command buffers 125 can be maintained with each process scheduled for execution on the APD 104.

CP 124 can be implemented in hardware, firmware, or software, or a combination thereof. In one embodiment. CP 124 is implemented as a reduced instruction set computer (RISC) engine with microcode for implementing logic including scheduling logic.

System 100 also includes a hardware scheduler (HWS) 128 for selecting a process from a run list 150 for execution on APD 104. HWS 128 can select processes from run list 150 using round robin methodology, priority level, or based on other scheduling policies. The priority level, for example, can be dynamically determined. HWS 128 can also include functionality to manage the run list 150 for example, by adding new processes and b\ deleting existing processes from nm-list 150. The run list management logic of HWS 128 is sometimes referred to as a run list controller (RLC).

In various embodiments of the present invention, when HWS 128 initiates the execution of a process from run list 150, CP 124 begins retrieving and executing commands from the corresponding command buffer 125 to some instances. CP 124 can generate one or more commands to be executed within APD 104, which correspond with commands received from CPU 102. In one embodiment, CP 124, together with other components, implements a prioritizing and scheduling of commands on APD 104 in a manner that improves or maximizes the utilization of the resources of APD 104 resources amid/or system 100.

Memory 106 can include non-persistent memory such as DRAM (not shown). Memory 106 can store, e.g., processing logic instructions, constant values, and variable values during execution of portions of applications or other processing logic. For example, in one embodiment, parts of control logic to perform one or more operations on CPU 102 can reside within memory 106 during execution of the respective portions of the operation by CPU 102.

During execution, respective applications, operating system functions, processing logic commands, and system software can reside in memory 106. Control logic commands fundamental to operating system 108 will generally reside in memory 106 during execution. Other software commands, including, for example, software scheduler 112 can also reside in memory 106 during execution of system 100.

In this example, memory 106 includes command buffers 125 that are used by CPU 102 to send commands to APD 104. Memory 106 also contains process lists and process information (e.g., active list 152 and process control blocks 154). These lists, as well as the information, are used by scheduling software executing on CPU 102 to communicate scheduling information to APD 104 and/or related scheduling hardware. Access to memory 106 can be managed by a memory controller 140, which is coupled to memory 106. For example, requests from CPU 102, or from other devices, for reading from or for writing to memory 106 are managed by the memory controller 140.

Referring back to other aspects of system 100, IOMMU 116 is a multi-context memory management unit. As used herein, context can be considered the environment within which synchronization and memory management is defined. The context includes a set of devices, the memory accessible to those devices, the corresponding memory properties and one or more command-queues used to schedule execution of an operation on memory objects.

In the example shown, communication infrastructure 109 interconnects the components of system 100 as needed. Communication infrastructure 109 can include (not shown) one or more of a peripheral component interconnect (PCI) bus, extended PCI (PCI-E) bus, advanced microcontroller bus architecture (AMBA) bus, advanced graphics port (AGP), or other such communication infrastructure. Communications infrastructure 109 can also include an Ethernet, or similar network, or any suitable physical communications infrastructure that satisfies an application's data transfer rate requirements. Communication infrastructure 109 includes the functionality to interconnect components including components of computing system 100.

In this example, operating system 108 includes functionality to manage the hardware components of system 100 and to provide common services. In various embodiments, operating system 108 can execute on CPU 102 and provide common services. These common services can include, for example, scheduling applications for execution within CPU 102, fault management, interrupt service, as well as processing the input and output of other applications.

In some embodiments, SWS 112 maintains an active list 152 in memory 106 of processes to be executed on APD 104. SWS 112 also selects a subset of the processes in active list 152 to be managed by HWS 128 in the hardware. Information relevant for running each process on APD 104 is communicated from CPU 102 to APD 104 through process control blocks (PCB) 154.

Processing logic for applications, operating system, and system software can include commands specified in a programming language such as C and/or in a hardware description language such as Verilog, RTL, or netlists, to enable ultimately configuring it manufacturing process through the generation of maskworks/photomasks to generate a hardware device embodying aspects of the invention described herein.

A person of skill in the art will understand, upon reading this description, that computing system 100 can include more or fewer components than shown in FIG. 1. For example, computing system 100 can include one or more input interfaces, non-volatile storage, one or more output interfaces, network interfaces, and one or more displays or display interfaces.

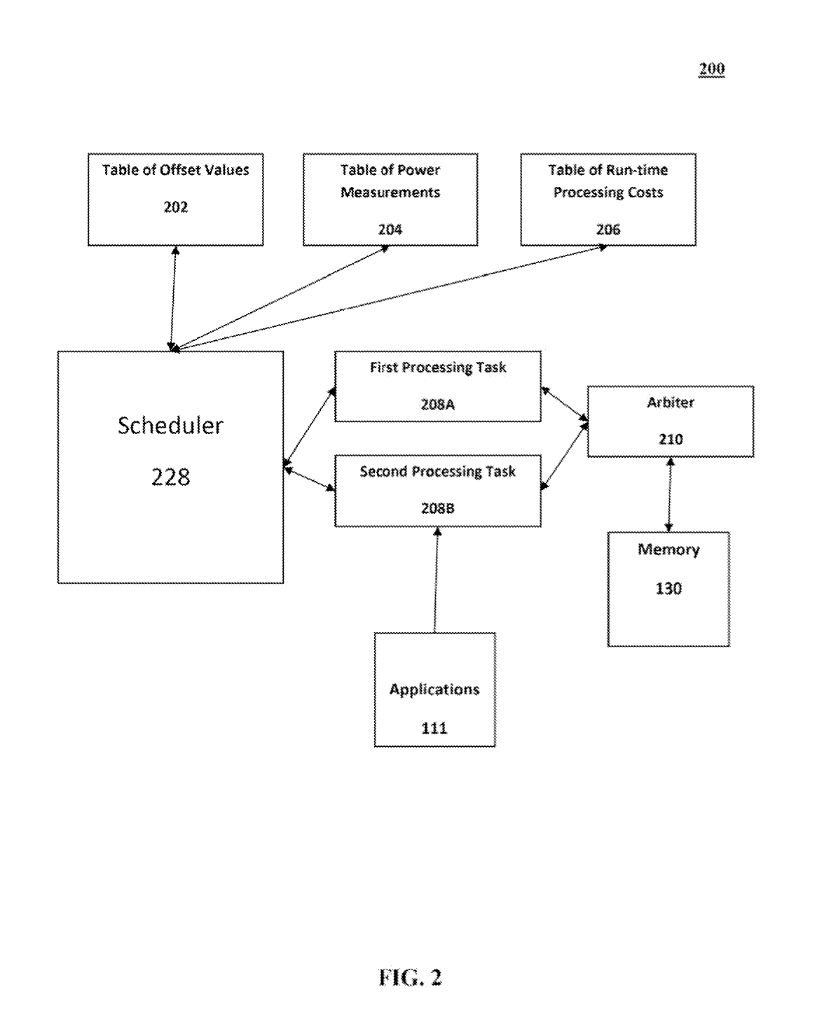

FIG. 2 is an illustration of a scheduling system 200, according to an embodiment of the present invention. In one example, scheduling system 200 includes scheduler 228, table of offset values 202, table of power measurements 204, table of run-time processing costs, 206, first processing task 208A, second processing task 208B, arbiter 210, memory 130, and applications 111, in an embodiment, scheduler 228 can be similar to HWS 128 discussed previously. Additionally, scheduler 228 can be a software scheduler, in another embodiment. Components of system 200 can be implemented as hardware, firmware, software, or any combination thereof. A person of ordinary skill in the art will appreciate that system 200 may include one or more software, hardware, and firmware components in addition to, or different from, that shown in the embodiment shown in FIG. 2.

In one example system 200 operates as follows: scheduler 228 is responsible for receiving data related to first processing task 208A and second processing task 208B. First processing task 208A and second processing task 208B operate on frames of data. For example, fast processing task 208A can be a video decoding operation, while second processing task 208B can be a video-post processing operation. First processing task 208A and second processing task 208B can be generated by applications 111, which may be a video playback application, for example.

In one example, scheduler 228 determines duration characteristics related to first processing task 208A and second processing task 208B. For example, the duration characteristics related to first processing task 208A and second processing task 208B are based on the execution times of the first and second processing tasks under different system conditions.

Scheduler 228 is configured to select an offset value from table of offset values 202 and apply the offset to the execution of first processing task 208A and second processing task 208B. Scheduler 228 measures duration characteristics when a specific offset is applied and stores these measurements in table of run, time processing, costs 206. Scheduler 228 repeats the measurement of processing time characteristics for a set of offset values retrieved, from table of offset values 202 and stores the measurements in table of run-time processing costs 206. Based on table of runtime processing costs 206 and table of power measurements 204, scheduler 128 selects an appropriate offset value. Arbiter 210 is then configured to use the selected offset value to manage access of memory 130 by first and second processing tasks 208A and 208B.

The execution of first processing task 208A and second processing task 208B can include the command processor (CP) of the accelerated processing device selecting a first and second processing task from a plurality of tasks within as run list (RU) of processes and executing the first and second processing tasks within a shader core. In an embodiment, scheduler 228 is responsible for populating the RL of processes. Examples of the first processing task 208A and second processing task 208B, as discussed above, include operations related to video playback with hardware acceleration of video-decoding and video post-processing functions. Such operations can compete for access to a common memory, according to an embodiment (e.g. system memory, graphics memory, or DRAM).

In one example, scheduler 228 is configured to use a smaller subset of processing tasks from an active list (AL) to generate the run list. Scheduler 228 may further be configured to perform as training session for the execution of first processing task 208A and second processing task 208B, according to an embodiment. During the training session, a plurality of offset values are applied to the execution of the first processing task 208A and second processing task 208B. An offset value indicates a difference in time in beginning the execution of first processing task 208A and second processing task 208B. In an embodiment, the plurality of offset values are applied incrementally. In this way, the values of the applied offset increases for duration of the training session on each frame of data. The values of the offset can increase at any increment suitable for the system. For example, applying an offset at small incremental increases may reveal only slight changes in the processing times and power consumption of system 200. Thus, system 200 can dynamically choose to apply offsets at a greater increments, during such scenarios.

In an embodiment, duration characteristics are determined during the execution of a training session by scheduler 228. Duration characteristics are time measurements of the system during the execution of lust processing task 208A and second processing task 208B. According to an embodiment, the duration characteristics are used in selecting an appropriate offset value. An appropriate offset value is one in which, when applied to the execution of two processing tasks, yields an efficient nut time, an acceptable idle time, and a minimum power consumption. As will be appreciated by those of ordinary skill in the art, the parameters (run time efficiency, idle time, power consumption, or others) may not all be optimized when the appropriate offset value is selected. In certain circumstances, it may be desirable for power consumption to be the most important consideration, as such an offset may be selected that improves power consumption while not improving any or all of the other parameters or, in some cases, resulting in less desirable or worse parameters. Accordingly, the process described herein to select an appropriate offset value may be configured dynamically.

In an example operation, the determination of the duration characteristics is performed as follows. Scheduler 228 retrieves a plurality of offset values from table of offset values 202. The table of offset values 202 can be generated based on predetermined values which may be hard-coded or generated based on previous training sessions. The table of offset values 202 can be stored on a memory of the GPU or a separate memory. As an offset value is retrieved from the table, first processing task 208A and second processing task 208B are executed based on the offset value. For example, an applied offset value of 0.3 milliseconds indicates that the initiation of first processing task 208A and second processing task 208B will take place with a 0.3 millisecond delay (e.g., initiate second processing task 208B 0.3 milliseconds after first processing task 208A is initiated). During the training session, the following duration characteristics are determined for each applied offset value: (i) duration of the first processing task 208A (DUR1), duration of the second processing task 208B (DUR2), (iii) idle time, and (iv) system period time. All duration characteristics are measured as a function of the applied offset values and dynamically stored in table of run-time processing costs 206. The duration characteristics will be described further below using FIG. 1

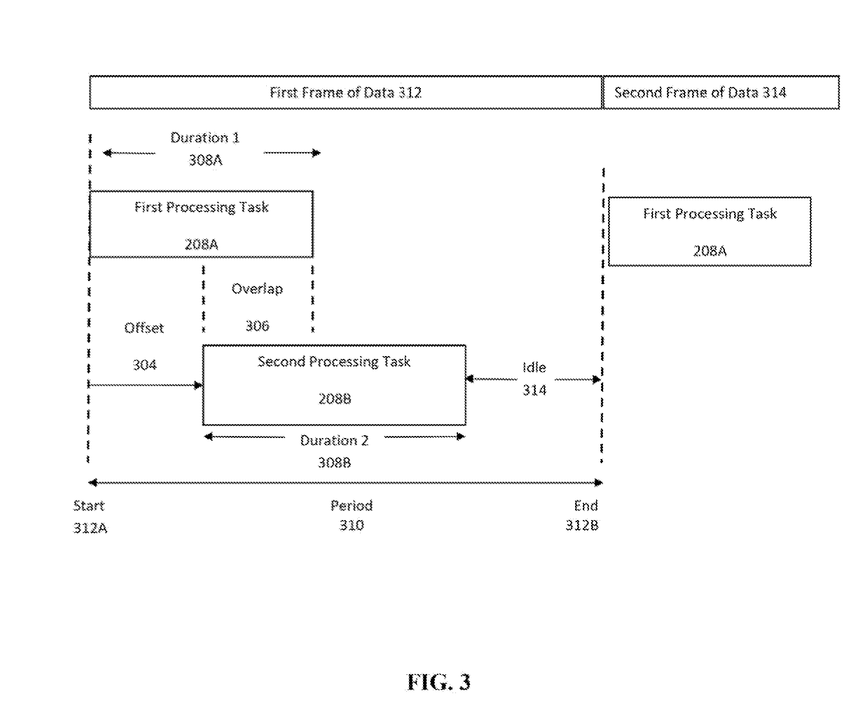

FIG. 3 shows a diagram 300 illustrating duration characteristics during a training session, according to an embodiment. In general, the first processing task 208A and second processing task 208B operate on frames of data, e.g., first frame of data 312 and second frame of data 314, during a training session 300. In one example, for a set of frames of data, first processing task 208A and second processing task 208B can operate on each frame of data, or every other frame of data, depending on the processing requirements. In an embodiment, the table of run-time processing costs 206 is dynamically updated as first processing task 208A and second processing task 208B are operating on frames of data.

In this example. DUR1 308A is the amount of time first processing task 208A needs to complete its entire operation. Likewise, DUR2 308B is the amount of time second processing task 208B needs to complete its entire operation. An offset value 304 is applied to first processing task 208A and second processing task 208B. When offset value 304 is applied, the start time 312A of the second processing, task 208B is delayed by the value of offset value 304. For example, if an offset value of 0.3 milliseconds is applied, first processing task 208A will be initiated at a start time 312A of 0 and second processing task 208B is initiated 0.3 seconds later (e.g., start time 312A of first processing task 208A+offset value 304.)

For each offset value 304 applied, the values of DUR1 308A and DUR2 308B are determined and stored in the table of run-time processing costs 206. In general, the maximum duration times for first processing task 208A and second processing task 208B (e.g., DUR1MAX, DUR2MAX) to complete their respective operations occurs when both processing tasks are competing for memory access at the same time and are executing in parallel. Such a scenario takes place when the first and second processing tasks are scheduled with no delay (e.g., offset 304=0). Thus, in an embodiment. DUR1MAX and DUR2MAX can be determined at the beginning of a training session when a first offset of value of 0 is retrieved from the table of offset values 202. An offset value of 0 indicates that first processing task 208A and second processing task 208 are initiated at the same time.

In one example, the minimum duration for first processing task 208A and second processing task 208B (e.g., DUR1MIN, DUR2MIN) to complete their respective operations occurs when both processing tasks are scheduled in a serial manner (e.g., no overlap 306=0). During such a scenario, the first processing task 208A and the second processing, task 208B do not compete for access to memory. Thus, each processing task is able to execute without interruption and at its fastest possible time.

In an embodiment, DUR1 MIN and DUR2MIN can be determined by measuring the processing times of the first processing task 208A and the second processing task 208B when a large enough offset value is selected to prevent any overlap 306 of the processing tasks. Such an offset value 304 can be determined by identify the normal execution time of the first processing task 208A when executed alone) and selecting the equivalent offset value, in an embodiment, no overlap of processing tasks occurs when the selected offset value 306 is equal to the processing time of DUR1MIN.

In an embodiment, a system idle time 314 is a measurement of time during which memory is not being accessed by first and second processing tasks 208A and 208B. The system idle time 314 indicates an inactive state after the execution of the first processing task 208A and second processing task 208B. Once the executions of the first and second processing tasks 208A/B are completed for a first frame of data 312, there is a time delay before the system repeats first processing task 208A and second processing 208B for second frame of data 314. This amount of time delay is the system idle time 314. During system idle time 314, first processing task 208A and second processing task 208B have completed their respective operations and the system has the ability to perform power saving tasks, such as placing the system in a power-save mode. In an embodiment, the system idle time 314 is measured for each offset value 304 retrieved from the table of offset values 202 and applied during the train session 300.

In an embodiment, a system period time 310 is a measurement of time for the entire system to complete all operations for a frame of data. A system period time is a measurement of the aggregate of the duration of the first processing task 208A, duration of the second processing task 208B, and the idle time 314. In an embodiment, the system period time 310 is measured for each offset value applied during the training session. In an embodiment, system period time 310 and system idle time 314 can be measured using a counter operated by the APD or CPU.

Returning to FIG. 2, in addition to table of run-time processing costs 206, scheduler 228 may be configured to use table of power measurements 204 in determining an appropriate offset value. Table of power measurements 204 includes power consumption values of the system 200 that are known prior to the execution of a training session. For example, table of power measurements 204 includes power measurements of the system during different states. According to an embodiment, a power comparison of the system 200 running in serial mode versus parallel mode for different states is measured and the respective values can be stored in an array of table of power measurements 204. For illustrative purposes, the difference between the power consumption of system 200 in serial mode versus parallel mode will be denoted as PJob12Diff. Thus, PJob12Diff is the difference in power consumption of running first processing task 208A and second processing, task 208A in serial and parallel mode for different states of the system. For example, the following formula can be used to calculate PJob12Diff:

Pjob12Diff=standalone power−system power,

where standalone power is the power consumed by the system 200 when first processing task 208A and second processing task 208A are run in serial mode, and system power is the power consumed by the system 200 when the first processing task 208A and second processing task 208B are run in parallel (e.g. max power consumed.)

As discussed previously. PJob12Diff can be measured for different states of the system 200, according to an embodiment. For example, first processing task 208A and second processing task 208B may access a portion of memory 130 in order to perform their respective operations on a first frame of data. During the idle time (after the first and processing second tasks are completed and prior to a repeat of the first and second processing tasks on a second frame of data), certain power saving modes can be enabled such as power gating. PT gating is a technique that reduces stand-by or leakage power. Thus, in a system that enables such power saying mechanisms, PJob12Diff can be measured when the power saving mechanism is both enabled and disabled. In another example, when operating on frames of graphics data, certain encoding styles or video post processing functions may need to be enabled depending on the kind of processing tasks that are executing (e.g., a video playback operation). Thus, PJob12Diff can be measured hu all system behavior scenarios that may exist. All the different PJob12Diff power measurements can be stored in the table of power measurements 204 and retrieved during the training, session when appropriate.

According, to an embodiment, a measure of power consumption per 1% of idle time (denoted as P1%Idle) may be calculated and stored in the table power measurements 204. When applying a retrieved offset value to the execution of processing tasks 208A and 208B, the idle time may increase, decrease, or remain the same. If the idle time increases, this is an indicator that overall power is saved. This is due to the fact that during the idle state of the system, the power saving mechanisms discussed above may be enabled in order to save power. If the idle time decreases, this is an indication that overall power consumption has increased. P1%Idle can be used to determine how much power consumption increase takes places per 1% decrease of idle time. Thus, the P1%Idle value can be used to select an appropriate offset value during the scenario that the idle time decreases. P1%Idle is calculated based on a ratio between an aggregate of PJob12Diff values for each system state and 90% of power usage during an idle time.

In an embodiment, the table of power measurements 204 may be included in a pre-manufactured application-specific integrated circuit (ASIC) included as part of CPU 102. An ASIC is an integrated circuit customized for a particular user, rather than intended for general-purpose use.

### Offset Selection Phase

In an embodiment, an offset selection phase is performed during each training session in order to determine the appropriate offset value. As discussed previously, processing times of a processing task will depend on several factors, such as memory demands of the processing tasks, how often the processing tasks access common memory buffers, and how often the jobs access common memory areas (e.g., same memory bank but different page).

In an embodiment, during the optimization phase, the values in the table of run-time processing costs 206 are compared as a function of the offset values retrieved from table of offset values 202. For example, the values of DUR1, DUR2, and idle time are compared for each selected offset value. If the duration of processing tasks 208A and 208B as a function of the applied offset values are not changing while idle time increases as a function of offset, this is an indication that the overall system power may be increased. In such a scenario, since the processing times of DUR1 and DUR2 are not affected as the applied offset increases and idle time is increasing, the system is able to identify that more power may be used in order to improve the processing times of DUR1 and DUR2. Thus, the system 200 may increase the power so that overall processing times of first processing task 208A and second processing task 208B may be improved.

In another embodiment, if a comparison of the values in the table of run-time processing costs as a function of offset indicates that idle time is always zero, the appropriate offset value that is selected is the value at which the duration of the aggregate of the first processing task 208A and the second processing task 208B (DUR1+DUR2) are at a minimum. In such a scenario, this is an indication of the lowest possible power consumption for system 200.

In an embodiment, if the overall duration of the first processing task 208A and second processing task 208B as a function of the offset value decreases, the overall system power consumption may still increase. This may occur due to a decrease in idle time. Thus, the overall system power consumption can depend on two factors: (i) idle power savings per 1% of idle time (P1%Idle), and (ii) power consumption difference of system 200 from running in serial vs. in parallel mode (PJob12Diff). In an embodiment, scheduler 228 can retrieve P1%Idle and PJob2Diff values from table of power measurements 204 and use these values to select an appropriate offset value.

Returning to FIG. 3, in order to determine the appropriate offset value for offset 304, a power consumption change is calculated during the idle time 314 and during the time in which the first processing task 208A and second processing task 208B are executing (DUR1+DUR2). Power consumption change during the idle time 314 can be measured by determining the change in idle time 314 across all the offset values up until the system period time 310. The change in idle time 314 across all the offset values can then be quantified as a change in power by retrieving the associated P1%Idle value from the table of power values 204 and Using the following formula:

IdlePowerChange=100*P1%Idle*Delta[IdleTime(Offset)]/Period

Furthermore, a change in power consumption during the execution of the first processing task 208A and second processing task 208B (DUR1+DUR2) can be measured by determining the change in overlap 306 as a function of offset during the execution of first processing task 208A and second processing task 208B. The change in overlap 306 is then quantified as a change in power consumption by retrieving the associated PJob12Diff value from the table of empirical power values. The following formula may be used to calculate the change in power consumption during the execution of first processing task 208A and second processing task 208B:

JobsPowerChange=Pjob12Diff*{1−Delta[Overlap(Offset)]}

The calculated IdlePowerChange and JobsPowerChange can then be used by scheduler 228 to determine the appropriate offset value to be applied. The appropriate offset value will be selected, based on the minimum power consumption value across the range of offset values. For example, if JobsPowerChange−IdlePowerChange>0, then this is an indication that serialization yields the lowest power consumption and the corresponding offset value is the appropriate offset value.

The calculation of IdlePowerChange and JobsPowerChange above assumes that a linear relationship exists between the offset values and the power change (i.e., as offset increases, power increase or decreases proportionally). Thus, a person of ordinary skill in the art will appreciate that such a relationship may not exist between the offset values and power and other formulas may be used to calculate IdlePowerChange and JobsPowerChange based on different relationships.

Returning to FIG. 2, in an embodiment, once an appropriate offset value is selected, the selected offset value is used by system 200 to execute the first and second processing tasks 208A and 208B. According to an embodiment, the appropriate offset value is used by system 200 until a processing change is detected. For example, if a different encoding pattern is detected during video playback, the training session will be restarted in order to determine the appropriate offset value for the detected encoding pattern. In another embodiment, the appropriate offset value is used by system 200 when a periodic value is reached. For example, system 200 may be configured to perform a training session and selecting an appropriate offset value every 10 seconds.

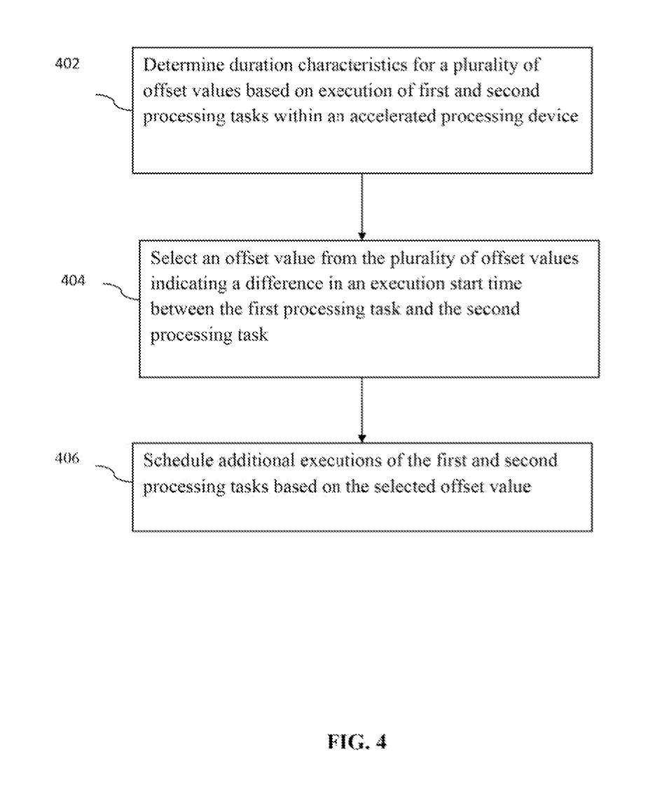

FIG. 4 is a flowchart depicting an exemplary method 400, according to an embodiment of the present invention. For ease of explanation, system 100 in FIG. 1 and system 200 in FIG. 2 will be used to describe method 400, but is not intended to be limited thereto. In one example, method 400 can be used for managing task scheduling on an accelerated processing device. The method 400 may not occur in the order shown, or require all of the steps.

In step 402, duration characteristics for a plurality of offset values are determined based on execution of first and second processing tasks within an accelerated processing device. For example, step 402 may be performed by scheduler 228 of FIG. 2.

The duration characteristics related to first and second processing tasks are based on the execution times of the first and second processing tasks under different system conditions. Scheduler 228 is configured to select an offset value from a table of offset values and apply the offset to the execution of first and second processing tasks. Scheduler 228 measures duration characteristics when a specific offset is applied and stores these measurements in a table of run-time processing costs. Scheduler 228 repeats the measurement of duration characteristics for a set of offset values retrieved from the table of offset values and dynamically updates the measurements in the table of run-time processing costs.

In step 404, an offset value from the plurality of offset values is selected. For example, step 404 may be performed by scheduler 228 of FIG. 2. The selected offset value indicates a difference in an execution start time between the first processing task and the second processing task. In an embodiment, the values in the table of run-time processing costs generated, in step 402 are compared as a function of the offset values retrieved from table of offset values. For example, the duration of processing times of the first and second processing tasks along with an idle time of the system can be compared for each selected offset value. If the duration of the first and second processing tasks as a function of the applied offset values are not changing, and idle time increases as a function of the offset value, the system is configured to increase power so that overall processing times of the first and second processing tasks can be improved.

In another embodiment, if a comparison of the values in the table of run-time processing costs as a function of offset indicates that idle time is always zero, the appropriate offset value that is selected is the value at which the duration of the aggregate of the first and second processing tasks are at a minimum.

In an embodiment, if the overall duration of the first and second processing tasks as a function of the offset value decreases and the idle time decreases, the scheduler 228 is configured to use the Reiterated table of run-time processing costs and a table of power measurements in order to select the appropriate offset value. The table of power measurements includes power consumption values of the system that are measured prior to the execution of the system. For example, the table of power measurements includes power measurements of the system during different processing states. According to an embodiment, a power comparison of the system running in serial mode versus parallel mode for different states is measured and the respective values can be stored in an array of the table of power measurements. Additionally, a measure of power consumption per 1% of idle time (denoted as P1%Idle) may be calculated and stored in the table power measurements, according to an embodiment. The appropriate offset value is selected based on the formulas discussed above, with the goal of selecting the appropriate offset value based on a balance between an overall power consumption, idle time power consumption savings, and processing times of the first and second processing tasks.

In step 406, additional executions of the first and second processing tasks are scheduled based on the selected offset value. For example, step 406 may be performed by scheduler 228 and arbiter 210 of FIG. 2. Once the appropriate offset value is determined in step 404, scheduler 228 and arbiter 210 are configured to control the start of the processing of the first and second processing tasks based on the offset value. Thus, scheduler 228 will schedule the first processing task and stagger the start of the second processing task by the value of the selected offset value. Scheduler 228 is configured to notify the APD of the processing schedule of the first and second processing tasks based on the selected offset value. Arbiter 210 will then receive the information related to the scheduling of the processing tasks and manage memory access by each processing task based on offset related delay between the processing tasks. In an embodiment, scheduler 228 and arbiter 210 are configured to use the selected offset value until a processing change is detected. Additionally, according to an embodiment, the selected offset value is used for a pre-configured periodic interval.

The Summary and Abstract sections may set forth one or more but not all exemplary embodiments of the present invention as contemplated by the inventor(s), and thus, are not intended to limit the present invention and the appended claims any way.

The embodiments herein have been described above with the aid of functional building, blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed, embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for managing processes comprising:
determining duration characteristics for a plurality of offset values based on execution of first and second processing tasks within an accelerated, processing device;
selecting an offset value from the plurality of offset values indicating a difference in an execution start time between the first processing task and the second processing task; and
scheduling additional executions of the first and second processing tasks based on the selected offset value.

2. The method of claim 1, wherein each of the first and second processing tasks are one of a graphics process, audio process and a compute process.

3. The method of claim 1, wherein the first and second processing tasks perform a memory access, and the method further comprises:
retrieving the plurality of offset values from a table of offset values;
executing the first and second processing tasks based on the retrieved offset values;
determining a completion time of the execution of the first and second processing tasks thr each of the retrieved offset values;
determining a system idle time for each of the retrieved offset values, the system idle time indicating an inactive state during the execution of the first and second processing tasks;
selecting an appropriate offset value from the plurality of the offset values, based on a comparison of the completion time and the idle time; and
scheduling additional executions of the first and second processing tasks based on the selected offset value.

4. The method of claim 3, wherein the selecting an appropriate offset value thither comprises:
determining whether the system idle time remains constant across a range of the plurality of offset values; and
in response to the system idle time remaining constant, selecting the offset value that generated a minimum completion time of the first and second processing tasks.

5. The method of claim 3, wherein the selecting an appropriate offset value further comprises:
determining whether the system idle time remains constant across a range of the plurality offset values; and
in response to the system idle time not being constant:
retrieving a table of predetermined power processing measurements;
calculating a change in power based on the predetermined power processing measurements; and
selecting the offset value that generated (i) a minimum completion time of the first and second processing tasks and (ii) a minimum power consumption.

6. The method of claim 5, wherein the table of predetermined power processing measurements includes values related to processing times of the first and second processing tasks in a serial mode and in a parallel mode.

7. The method of claim 1, wherein, for each of the plurality of offset values, the determining comprises;
measuring a processing time of the execution of the first processing task;
measuring a processing time of the execution of the second processing task; and
generating a table of values including the measured processing times.

8. The method of claim 1, in response to processing times of the first and second processing tasks remaining constant and idle time increasing, further comprising increasing system power over a range of offset values.

9. The method of claim 1, wherein the offset values are based on a time measurement.

10. The method of claim 1, wherein the determining and selecting are initiated based on receiving an indication of a processing change.

11. The method of claim 1, wherein the determining and selecting are initiated at a preconfigured periodicity.

12. The method of claim 1, wherein the first and second processing tasks execute on frames of graphics data.

13. The method of claim 1, wherein the selected offset value is used until a processing change is detected.

14. A processing device comprising:
a scheduler configured to:
determine duration characteristics for a plurality of offset values based on execution of first and second processing tasks;
select an offset value from the plurality of offset values indicating a difference in an execution start time between the first processing task and the second processing task; and
schedule additional executions of the first and second processing tasks based on the selected offset value.

15. The processing device of claim 14, wherein the first and second processing tasks are one of a graphics process, audio process and a compute process.

16. The processing device of claim 14, wherein the scheduler is further configured to:
retrieve the plurality of offset values from a table of offset values;
execute the first and second processing tasks based on the retrieved offset values;
determine a completion time of the execution of the first and second processing tasks thr each of the retrieved offset values;
determine a system idle time for each of the retrieved offset values, the system idle time indicating an inactive state during the execution of the first and second processing tasks;
select an appropriate. Whet value from the plurality of the offset values, based on a comparison of the completion time and the idle time; and
schedule additional executions of the first and second processing tasks based on the selected offset value.

17. The processing device of claim 16, wherein the scheduler is further configured to:
determine whether the system idle time remains constant across a range of the plurality of offset values; and
in response to the system idle time remaining constant, select the offset value that generated a minimum completion time of the first and second processing tasks.

18. The processing device of claim 16, wherein the scheduler is further configured to:
determine whether the system idle time remains constant across a range of the plurality offset values; and
in response to the system idle time not being constant:
retrieve a table of predetermined power processing measurements;
calculate a change in power based on the predetermined power processing measurements; and
select the offset value that generated (i) a minimum completion time of the first and second processing tasks and (ii) as minimum power consumption.

19. The processing device of claim 14, further comprising:
a shader core configured to increase system power in response to processing times of the first and second processing tasks remaining unchanged over time and idle time increasing over a range of offset values.

20. A computer-readable storage device having instructions stored thereon, execution of which, by a computing device, causes the computing device to perform operations comprising:
determining duration characteristics for a plurality of offset values based on execution of first and second processing tasks;
selecting an offset value from the plurality of offset values indicating a difference in an execution start time between the first processing task and the second processing task; and
scheduling additional executions of the first and second processing tasks based on the selected offset value.
